(19) United States
(12) Patent Application Publication
(10) Pub. No.: US 2004/0187163 A1
(43) Pub. Date: Sep. 23, 2004

(54) Addressable tap used in cable TV network

(76) Inventors: Yung-Liang Chang, KaoHsiung City (TW); Chih-Chou Shih, Taichung City (TW)

Correspondence Address: Judson K. Champlin, Westman, Champlin & Kelly, Suite 1600, 900 Second Avenue South, Minneapolis, MN, 55402-3319, US

(21) Appl. No.: 10/801,300

(22) Filed: Mar. 16, 2004

(30) Foreign Application Priority Data
Mar. 20, 2003 (CN) 03224630.7

(51) Int. Cl. H04N 7/173

(52) U.S. Cl. 725/127; 725/120

(57) ABSTRACT

An addressable Tap used in cable TV networks consisting of a power supply module, a filter demodulation module, a control module and 8 switches. Said power supply module, filter demodulation module and switches are electrically connected to the control module. Said modules and switches are all installed on a PCB and contained in a housing, which is compatible and about plus minus 30% of the existing traditional installed Tap in size; said control module uses high performance microprocessor, switches are micro RF switches in order to be of the smallest total size. Compared with the existing technology, this invention is convenient in installation with low costs and will not interrupt the transmitted CATV signal. This invention has excellent control effects by high isolation and with interference signal on this RF switch for its direct cutting-off signals to users who owe payments, its continuous rapid switching between on and off or its ability to add interference into the signals.

### FIELD OF INVENTION

This invention is directed to the image communication technological sector, especially an addressable Tap used in cable TV that can be managed in payment collection.

### BACKGROUND OF THE INVENTION

As a tertiary industrial sector, cable TV operators need to control signals transmitted to the users in accordance with their payment. At present, most of the controls are done by installation and dismantle of cables connected to the users. With fast development of cable TV industry, this kind of manual management cannot cope with the continuous expansion of cable TV networks. Hence, cable TV operators urgently need an automatic system to control signals transmitted to users to replace the existing manual method. In this background, an addressable Tap used in the user terminals is developed. By way of this addressable tap, cable TV stations can manipulate remote control over signals transmitted to the users. However, existing addressable Taps available on the market have the following disadvantages:

1. Inconvenience in installation. Addressable Taps available on the markets are different size, resulting in incompatibility with the existing Traditional installed Taps in the cable TV networks. In case of application, existing cable TV networks have to be upgraded with much waste of both labor and materials, even need to cut the CATV trunk link to interrupt the CATV signal.

2. Inferior switching-off at users. Many addressable Taps available on the market now have isolation problems in switching-off state, thus making TV stations unable to realize effective control over signals transmitted to users.

### BRIEF SUMMARY OF THE INVENTION

Technical problems that the present invention aims to solve is avoiding the disadvantages in the existing technology by way of a new addressable Tap, which has compatible size of the existing traditional installed Taps used in cable TV networks and has high isolation in switching-off to replace the existing traditional installed Taps used in cable TV networks now.

The technical problems that this invention aims at can be solved by the following plan:

Design and make an addressable Tap for use in cable TV networks that shall consist of a power supply module, a filter demodulation module, a control module and eight RF switches. Said power supply module, filter modulation module and RF switches are electrically connected with said control module respectively. All the modules and RF switches are installed onto the PCB and contained in a housing. Said housing has compatible and a dimension plus minus 30% of the existing traditional installed Tap standard housing; said control module uses a high performance microprocessor and said switches are RF micro-switches to make its size the smallest. The filter demodulation module will demodulate the control signals from the input signals and transmit the demodulated signals to said control module. Said control module receives the control signals to switch off or interfere with the targeted RF switches.

As the shape, size and specification of the present invention is the same as or compatible to the existing traditional installed Taps used in cable TV networks, what is needed, is only to replace the faceplate of existing traditional installed one with the present invention in installation and no need to lay new wiring or re-work the trunk CATV cable connector to interrupt the transmitted CATV signal. Compared with the existing technology, this invention is convenient in installation with low costs and will not interrupt the transmitted CATV signal.

This invention has excellent control effects by high isolation and with interference signal on this RF switch for its direct cutting-off signals to users who owe payments, its continuous rapid switching between on and off or its ability to add interference into the signals.

### BRIEF DESCRIPTION OF THE DRAWINGS

FIG. 1 is a sketch of three-dimensional appearance of the present invention addressable Tap.

FIG. 2 is an electric block diagram of the addressable Tap.

FIG. 3 is a sketch of a preferred embodiment for the present invention addressable Tap controlling the output terminal switch.

FIG. 4 is a sketch of another preferred embodiment for the present invention addressable Tap controlling the output terminal switch.

FIG. 5 is a sketch of the third preferred embodiment for the present invention addressable Tap controlling the output terminal switch.

### PREFERRED EMBODIMENT

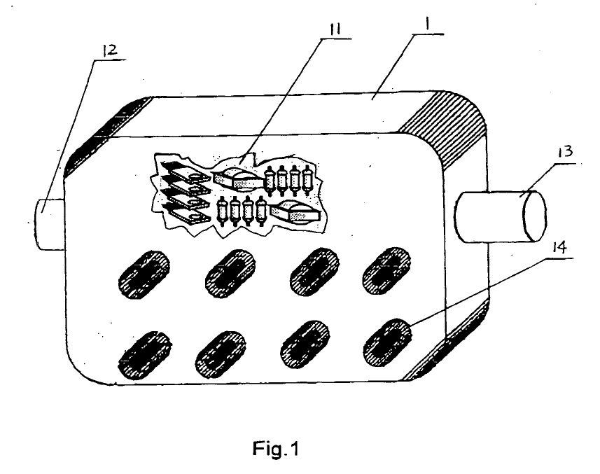

An addressable Tap for cable TV networks is shown in FIG. 1, which consists of a housing 1 and PCB 11 therein. Said housing 1 is the same as or compatible to the existing traditional installed Taps used in cable TV networks in size, shape and specification. The left terminal 12 of said housing 1 is for signal input and is connected to the precedent addressable Tap; the right terminal 13 is for signal output and is connected with the next addressable Tap. The eight terminals 14 in the front faceplate of said housing 1 are connected to users. Said housing 1 is within plus minus 30% of the existing traditional installed Tap housing in size. Said existing traditional installed Tap is in size of 120 mm×90 mm×40 mm. Said PCB consists of a power supply model 2, a filter demodulation module 3 and a control module 4 and 8 RF switches 5 (in order to be clear, only 4 RF switches are shown in the figure). Said power supply module 2, filter demodulation module 3 and RF switches 5 are electrically connected to said control module 4; said control module 4 uses high performance micro switch and RF switches are micro ones in order to make this invention have the smallest size. The filter demodulation module 3 will demodulate control signals from the input signals and transmit the demodulated control signals to said control module 4, which receives said control signals and switch off the targeted RF switches or add interference to them. Said addressable Taps are installed in front of users to replace the existing traditional installed Taps used in the cable TV networks.

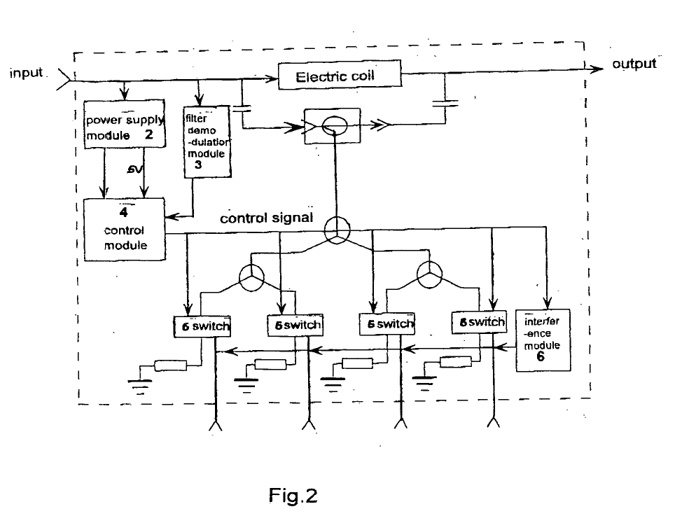

FIG. 2 is an electric block diagram of the addressable Tap in this invention. At the input terminal are Input voltage of AC 60V, 110 MHz control signals and cable TV signals. Said power supply module 2 will convert AC 60V voltage into DC 5V output to said control module 4. At the same time, filter demodulation module 3 demodulates control signals from the input signals and transmits the control signals to the control module 4, which receives the control signals from the filter demodulation module 3 to control the RF switches 5, or control the signal source. The cable TV signals and control signals inside the input are coupled to the RF switches 5 through capacitors.

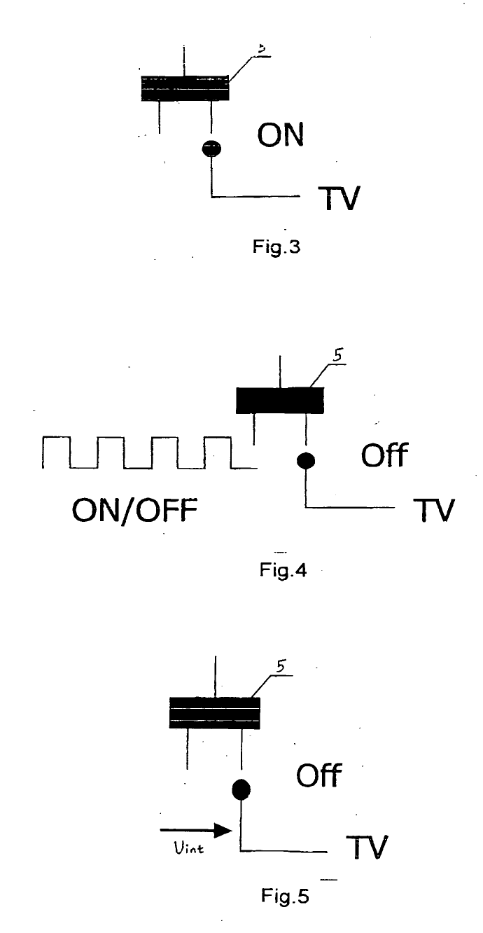

The present invention addressable Tap can control TV signals transmitted to users in three ways: firstly, adopting single-pole double-throw RF switch to realize on-off control over the output as shown in FIG. 3 to make users unable to watch TV programs; secondly, considering the fact that as sensitivity for TV signal reception is being enhanced continuously thus making it difficult to totally cut off signals to users by way of simple on-off control, this invention uses control software to issue rapid continuous on-off instructions to make fast switching of signals at the users' terminals, thus the signals received by the users cause TV images strongly flicker that cannot be watched by users; thirdly, an interference module 6 is inserted between said control module 4 and RF switches 5, said interference module 6 will receive control signals from said control module 4 to generate interference signals to interfere with the target RF switches 5. Owing to interference source is added in front of signal output terminal, images on users' TV will show ripples, snowflakes or flickers, so users cannot watch TV programs.

What is claimed is:

1. An addressable Tap used in cable TV networks consisting of a power supply module, a filter demodulation module, a control module and 8 switches. Said power supply module, filter demodulation module and switches are electrically connected to the control module, which is characterized by:
Said modules and switches are all installed on a PCB and contained in a housing, which is compatible and about plus minus 30% of the existing traditional installed Tap in size; said control module uses high performance microprocessor, switches are micro RF switches in order to be of the smallest total size.

2. An addressable Tap used in cable TV networks as defined in claim 1 is characterized by: said housing has a main signal input terminal located at the left side, which is connected with the precedent addressable Tap and a main signal output terminal at the right side, which is connected with the next addressable Tap. Said housing has also eight output terminals on its front surface, which are connected with the users.

3. An addressable Tap used in cable TV networks as defined in claim 1 is characterized by: an interference module is inserted between said control module and RF switches and said interference module will receive control signals from said control module to generate interference signals on the target RF switches.
